(19) United States
(12) Patent Application Publication
(10) Pub. No.: US 2018/0285950 A1
(43) Pub. Date: Oct. 4, 2018

(54) TRANSACTION METHOD OF ONLINE SHOPPING AND TRANSACTION SYSTEM THEREOF

(71) Applicant: HAO-CHIEH LEE, TAOYUAN CITY (TW)

(72) Inventor: HAO-CHIEH LEE, TAOYUAN CITY (TW)

(21) Appl. No.: 15/473,271

(22) Filed: Mar. 29, 2017

(51) Int. Cl. G06Q 30/06; G06Q 10/08; G06Q 20/02

(52) U.S. Cl. CPC G06Q 30/0609; G06Q 20/02; G06Q 10/083

(57) ABSTRACT

A transaction method of online shopping and a transaction system thereof are provided. A buyer and a seller respectively deposit guarantee money (or membership fee) to a third party financial institution in advance, so that the buyer and the seller are qualified to conduct online transactions at a shopping platform. After the online transactions are completed (i.e., the transactions between the buyer and the seller are correctly completed), the third party financial institution respectively returns the guarantee money (or the deposited membership fee) to the buyer and the seller. Accordingly, the present disclosure is advantageous to minimize the risk of fraudulent buyers and sellers, thereby protecting financial transactions conducted between the both parties.

### BACKGROUND

### 1. Technical Field

The present disclosure relates to a transaction method of online shopping and a transaction system thereof, in particular, to a transaction method of online shopping and a transaction system thereof capable of protecting financial transactions conducted between both parties.

### 2. Description of Related Art

For the sake of protecting the rights between both parties, paying and receiving cash mostly depend on cash flow platforms, namely, third party financial institutions when conducting online transactions. For example, a buyer orders desired merchandise at a shopping platform and then remits a transaction amount to a third party financial institution, such as a specific bank account, a seller is notified by the third party financial institution to ship the ordered merchandise to the buyer when the remittance to the third party financial institution is confirmed.

A third party financial institution can protect the right of the buyer, whereas the seller's right would be prejudiced. For example, when a first buyer orders first merchandise at a shopping platform, a third party financial institution provides the first buyer with a first merchandise account. Then, the first buyer deliberately establishes second merchandise which is false at the shopping platform and designates the first merchandise account as the remittance account. After that, when a second buyer orders the second merchandise and remits the transaction amount to the remittance account designated by the first buyer, the third party financial institution notifies the first seller to ship the first merchandise to the first buyer, and as a result the first buyer gains the first merchandise by cheating and the second buyer loses the transaction amount. In addition, the account of the first seller may accordingly show abnormality due to the unusual transaction.

Consequently, conventional online shopping methods are incapable of protecting the rights between both parties at the same time.

### SUMMARY

The primary purpose of the present disclosure is to provide a transaction method of online shopping and a transaction system thereof, in which a buyer and a seller respectively deposit guarantee money (or membership fee) in a third financial institution in advance to minimize the risk of fraudulent buyers and sellers.

The transaction method of online shopping provided in the present disclosure is adapted to a transaction system, and includes a shopping platform and a third party financial host, wherein the method comprises the following steps: (a) a buyer and a seller respectively depositing guarantee money to the third party financial host, so that the buyer and the seller are qualified to conduct online transactions at the shopping platform; (b) after the buyer orders desired merchandise through the shopping platform and remits a transaction amount to the third party financial host, the third financial host notifying the seller to ship the ordered merchandise to the buyer through the shopping platform; (c) after the shopping platform confirms that the shipment is successfully delivered to the buyer, the third party financial host transferring the transaction amount to the seller according to a customer satisfaction degree or an expiration of cooling-off period; and (d) the third party financial host respectively returning the guarantee money to the buyer and the seller.

The present disclosure further provides a transaction system of online shopping which includes a shopping platform and a third party financial host. The shopping platform is connected to a buyer station and a seller station. The third party financial host is connected to the buyer station, the seller station and the shopping platform, and receives guarantee money respectively deposited by the buyer and the seller, so that the buyer and the seller are qualified to conduct online transactions at the shopping platform. After the buyer orders desired merchandise through the shopping platform and remits a transaction amount to the third party financial host, the third financial host notifies the seller to ship the ordered merchandise to the buyer through the shopping platform. After the shopping platform confirms that the shipment is successfully delivered to the buyer, the third party financial host transfers the transaction amount to the seller according to a customer satisfaction degree or an expiration of cooling-off period. After the transaction amount is transferred to the seller by the third party financial host, the third party financial host respectively returns the guarantee money to the buyer and the seller. When the buyer withdraws from the shopping platform, the third party financial host returns the guarantee money to the buyer, and when the seller withdraws from the shopping platform, the third party financial host returns the guarantee money to the seller.

To sum up, a buyer and a seller respectively deposit guarantee money (or membership fee) to a third party financial institution in advance, so that the buyer and the seller are qualified to conduct online transactions at a shopping platform. After the online transactions are completed (i.e., the transactions between the buyer and the seller are correctly completed), the third party financial institution respectively returns the guarantee money (or the deposited membership fee) to the buyer and the seller. Accordingly, a transaction method of online shopping and a transaction system thereof provided by the present disclosure is advantageous to minimize the risk of fraudulent buyers and sellers, thereby protecting financial transactions conducted between the both parties.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram illustrating a transaction system of online shopping of an embodiment of the present disclosure.

FIG. 2 is a flow chart illustrating a transaction method of online shopping of an embodiment of the present disclosure.

FIG. 3A is a schematic diagram illustrating how a buyer and a seller of an embodiment of the present disclosure are qualified to conduct online transactions at a shopping platform.

FIG. 3B is a schematic diagram illustrating a buyer of an embodiment of the present disclosure buying merchandise.

FIG. 3C is a schematic diagram illustrating a buyer of an embodiment of the present disclosure expressing the customers satisfaction degree.

FIG. 3D is a schematic diagram illustrating a buyer and a seller of an embodiment of the present disclosure withdrawing from a shopping platform.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

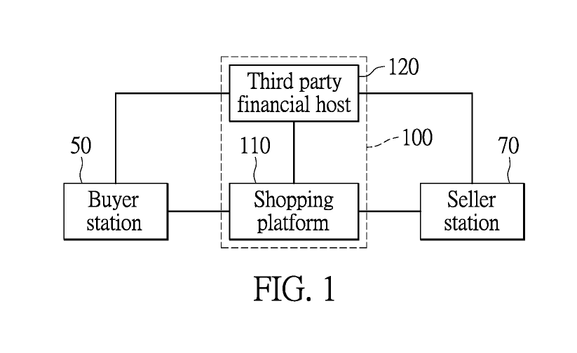

Reference is made to FIG. 1. FIG. 1 is a schematic diagram illustrating a transaction system of online shopping of an embodiment of the present disclosure. As shown in FIG. 1, a transaction system of online shopping 100 includes a shopping platform 110 and a third party financial host 120. The shopping platform 110 is connected to a buyer station 50 and a seller station 70. Further, the seller provides at least one piece of merchandise to the shopping platform 110 through the seller station 70, and the buyer can order desired merchandise displayed at the shopping platform 110 through the buyer station 50.

The third party financial host 120 is connected to the buyer station 50, the seller station 70 and the shopping platform 110, and receives guarantee money respectively deposited by the buyer and the seller, so that the buyer and the seller are qualified to conduct online transactions at the shopping platform 110. Alternately, the buyer and the seller can deposit the guarantee money before or after the online transactions are completed, or any time point before the merchandise ordered by the buyer is shipped to the buyer, and the present disclosure is not limited thereto.

When the shopping platform 110 receives a merchandise order from the buyer and the buyer remits a transaction amount to the third party financial host 120 through the buyer station 50, the third party financial host 120 notifies the seller through the shopping platform 110 to ship the ordered merchandise to the buyer.

After the ordered merchandise is shipped to the buyer, the shopping platform 110 confirms whether the shipment is successfully delivered to the buyer. Here, the delivery can be confirmed based on that the buyer actively sends an arrival notification to the shopping platform 110, or the logistics company sends an arrival notification after the shipment is successfully delivered to the buyer, and the present disclosure is not limited thereto. After that, the third party financial host 120 transfers the transaction amount to the seller through the seller station 70 according to a customer satisfaction degree or an expiration of cooling-off period (e.g. within seven days). In the present embodiment, the customer satisfaction degree indicates that the ordered merchandise meets the buyer's satisfaction and is not returned to the seller.

When the buyer is unsatisfied with the ordered merchandise and returns it to the seller before an expiration of cooling-off period (e.g. within days), the third party financial host 120 returns the transaction amount to the buyer (i.e. a refund to the buyer), which indicates that the buyer is unsatisfied with the ordered merchandise. In the present embodiment, the customer satisfaction degree is sent to the third party financial host 120 through the buyer station 50, or is sent to the third party financial host 120 by the buyer station 50 through the shopping platform 110, and the present disclosure is not limited thereto.

The third party financial host 120 respectively returns the guarantee money to the buyer and the seller when the transaction amount is transferred to the seller, or the third party financial host 120 returns the guarantee money to the buyer when the buyer withdraws from the shopping platform 110, or the third party financial host 120 returns the guarantee money to the seller when the seller withdraws from the shopping platform 110, and the present disclosure is not limited thereto.

As mentioned above, the buyer and the seller can deposit the guarantee money to the third party financial host 120 before or after the online transactions are completed, and the third party financial host 120 respectively returns the guarantee money to the buyer and the seller when the buyer confirms that the ordered merchandise has been successfully delivered, so that the risk of fraudulent buyers and sellers can be minimized to protect the financial transaction between both parties.

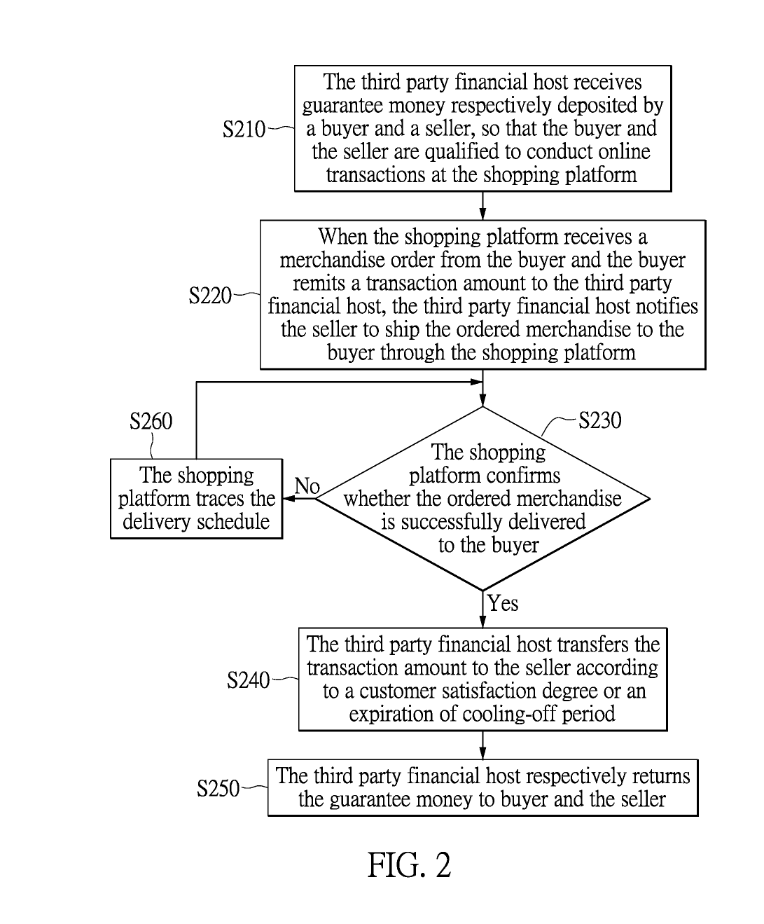

According to the aforementioned embodiments, the present disclosure further provides a transaction method of online shopping adapted to a transaction system 100. Reference is made FIG. 2 and FIG. 1 together, wherein FIG. 2 is a flow chart illustrating a transaction method of online shopping of an embodiment of the present disclosure. The method includes the following steps: in the transaction system 100, the third party financial host 120 receiving guarantee money respectively deposited by a buyer and a seller, so that the buyer and the seller are qualified to conduct online transactions at the shopping platform 110 (step 210). Here, the timing of the buyer and the seller respectively depositing the guarantee money to the third party financial host 120 has been described in the former embodiment, and unnecessary details are therefore not repeated herein.

When the shopping platform 110 receives a merchandise order from the buyer and the buyer remits a transaction amount to the third party financial host 120, the third party financial host 120 notifies the seller to ship the ordered merchandise to the buyer through the shopping platform 110 (step 220). Here, the detail with respect to step 220 has been described in the former embodiment, and unnecessary details are therefore not repeated herein.

In the process of shipping, the shopping platform 110 confirms whether the ordered merchandise is successfully delivered to the buyer (step 230). When the shopping platform 110 confirms that the ordered merchandise has been successfully delivered to the buyer, the transaction system 100 executes step 240. On the contrary, when the shopping platform 110 confirms that the shipment is not successfully delivered, the transaction system 100 executes step 260.

In step 260, the shopping platform 110 traces the delivery schedule, and notifies the seller whether to re-ship the ordered merchandise to the buyer or not depending on the delivery confirmation. Here, the shopping platform 110 can trace the delivery schedule by contacting with the logistics or through other manners, and the present disclosure is not limited thereto.

In step 240, the third party financial host 120 transfers the transaction amount to the seller according to a customer satisfaction degree or an expiration of cooling-off period to complete the financial transaction between both parties. Here, the detail with respect to step 240 has been described in the former embodiment, and unnecessary details are therefore not repeated herein.

After the third party financial host 120 transfers the transaction amount to the seller (i.e. step 240), the third party financial host 120 respectively returns the guarantee money to the buyer and the seller (step 260). Here, the timing of the third party financial host 120 respectively returning the guarantee money to the buyer and the seller has been described in the former embodiment, and unnecessary details are therefore not repeated herein.

Accordingly, by means of the transaction method of online shopping of the present embodiment, the risk of fraudulent buyers and sellers can be minimized to protect the financial transaction between both parties.

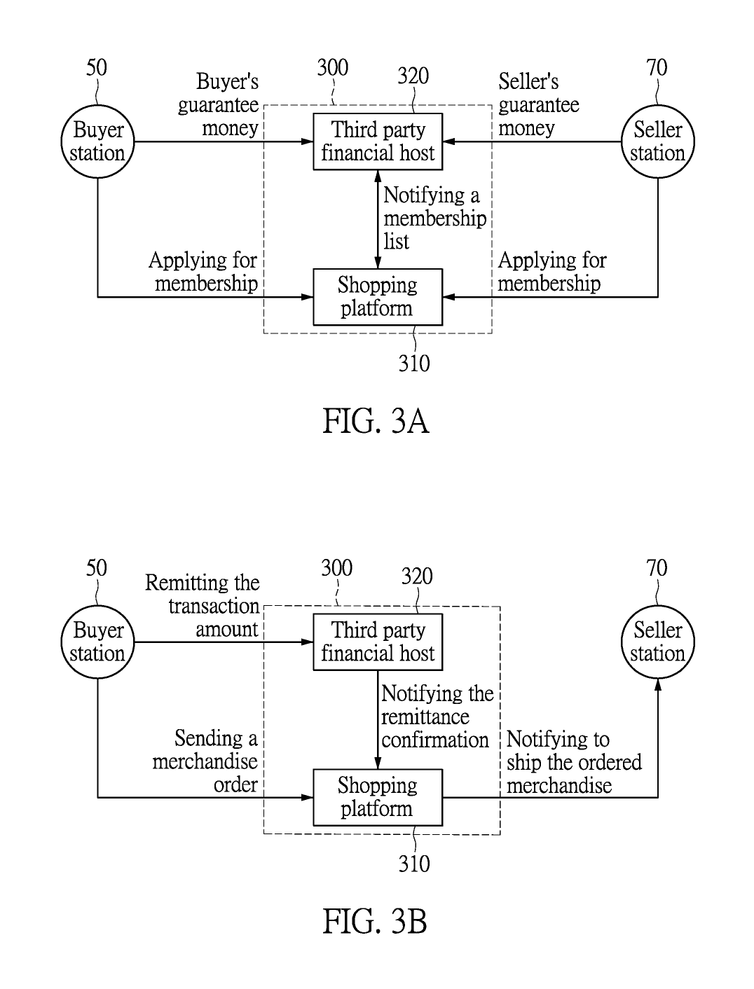

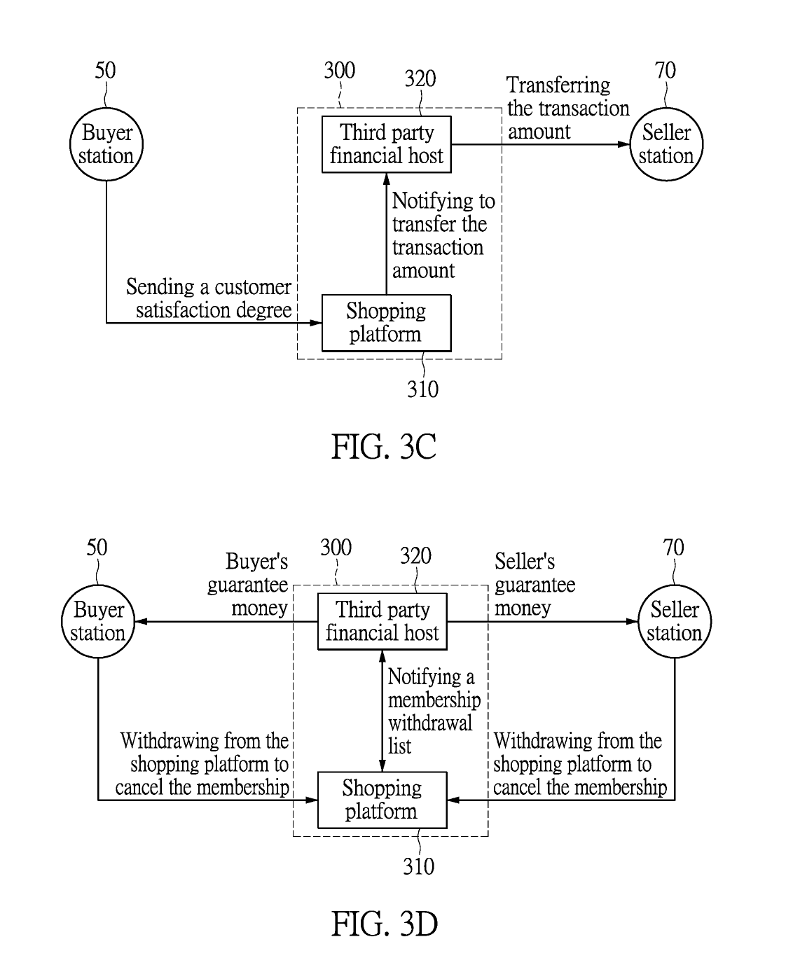

In the following embodiment, membership fees of a buyer and a seller are used as the guarantee money for illustration. As shown in FIG. 3A, in a transaction system 300, the buyer applies for membership of a shopping platform 310 through the buyer station 50 and the seller applies for membership of the shopping platform 310 through the seller station 70. When the membership applications pass, the shopping platform 310 sends a membership list to a third party financial host 320. After that, the buyer remits the membership fee to the third party financial host 310 as the guarantee money through the buyer station 50 and the seller remits the membership fee to the third party financial host 310 as the guarantee money through the seller station 70, so that both parties are qualified to conduct online transactions at the shopping platform 310.

As shown in FIG. 3B, the buyer orders desired merchandise at the shopping platform 310 and remits the transaction amount to the third party financial host 320 through the buyer station 50, and the third party financial host 320 notifies the shopping platform 310 that the remittance is confirmed. After that, the shopping platform 310 notifies the seller to ship the ordered merchandise to the buyer, and the seller accordingly arranges a shipment to the buyer.

As shown in FIG. 3C, when the shopping platform 310 confirms that the shipment has been successfully delivered to the buyer, the buyer represents a customer satisfaction degree to the shopping platform 310 through the buyer station 50 to express that the ordered merchandise meets the buyer's satisfaction and is not returned. After that, the shopping platform 310 notifies the third party financial host 320 that the transaction amount can be transferred to the seller, and the third party financial host 320 accordingly transfers the transaction amount to the seller station 70.

As shown in FIG. 3D, after the transaction amount is transferred to the seller station 70 by the third party financial host 320, the buyer can withdraw from the shopping platform 310 to cancel the membership through the buyer station 50, and the seller also can withdraw from the shopping platform 310 to cancel the membership through the seller station 70. After that, the shopping platform 310 sends a membership withdrawal list to the third party financial host 320, and the third party financial host 320 respectively returns the guarantee money to the buyer and the seller according to the membership withdrawal list.

In summary, a buyer and a seller respectively deposit guarantee money (or membership fee) to a third party financial institution in advance, so that the buyer and the seller are qualified to conduct online transactions at a shopping platform. After the online transactions are completed (i.e., the transactions between the buyer and the seller are correctly completed), the third party financial institution respectively returns the guarantee money (or the deposited membership fee) to the buyer and the seller. Accordingly, a transaction method of online shopping and a transaction system thereof provided by the present disclosure is advantageous to minimize the risk of fraudulent buyers and sellers, thereby protecting financial transactions conducted between the both parties.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A transaction method of online shopping adapted to a transaction system, comprising a shopping platform and a third party financial host, wherein the method comprises the following steps:
(a) a buyer and a seller respectively depositing guarantee money to the third party financial host, so that the buyer and the seller are qualified to conduct online transactions at the shopping platform;
(b) after the buyer orders desired merchandise at the shopping platform and remits a transaction amount to the third party financial host, the third financial host notifying the seller to ship the ordered merchandise to the buyer through the shopping platform;
(c) after the shopping platform confirms that the shipment is successfully delivered to the buyer, the third party financial host transferring the transaction amount to the seller according to a customer satisfaction degree or an expiration of cooling-off period; and
(d) the third party financial host respectively returning the guarantee money to the buyer and the seller.

2. The transaction method of online shopping according to claim 1, wherein when the shopping platform receives a merchandise order from the buyer, step (a) is executed.

3. The transaction method of online shopping according to claim 1, wherein the customer satisfaction degree of step (c) indicates whether the buyer is satisfied with the ordered merchandise or not.

4. The transaction method of online shopping according to claim 1, wherein in step (c), when the buyer is unsatisfied with the ordered merchandise and returns it to the seller before the expiration of cooling-off period, the third party financial host returns the transaction amount to the buyer.

5. The transaction method of online shopping according to claim 1, wherein when the third party financial host transfers the transaction amount to the seller, step (d) is executed.

6. The transaction method of online shopping according to claim 1, wherein when the buyer withdraws from the shopping platform to cancel membership, the third party financial host returns the guarantee money to the buyer, and when the seller withdraws from the shopping platform to cancel membership, the third party financial host returns the guarantee money to the seller.

7. A transaction system of online shopping, comprising:
a shopping platform connected to a buyer station and a seller station, and
a third party financial host connected to the buyer station, the seller station and the shopping platform, and receiving guarantee money respectively deposited by a buyer and a seller, so that the buyer and the seller are qualified to conduct online transactions at the shopping platform;
wherein after the buyer orders desired merchandise at the shopping platform and remits a transaction amount to the third party financial host, the third financial host notifies the seller to ship the ordered merchandise to the buyer through the shopping platform;
wherein after the shopping platform confirms that the shipment is successfully delivered to the buyer, the third party financial host transfers the transaction amount to the seller according to a customer satisfaction degree or an expiration of cooling-off period;
wherein after the transaction amount is transferred to the seller by the third party financial host, the third party financial host respectively returns the guarantee money to the buyer and the seller; when the buyer withdraws from the shopping platform to cancel membership, the third party financial host returns the guarantee money to the buyer, and when the seller withdraws from the shopping platform to cancel membership, the third party financial host returns the guarantee money to the seller.

8. The transaction system of online shopping according to claim 7, wherein when the shopping platform receives a merchandise order from the buyer, the third party financial host receives the guarantee money respectively deposited by the buyer and the seller, so that the buyer and the seller are qualified to conduct online transactions at the shopping platform.

9. The transaction system of online shopping according to claim 7, wherein the customer satisfaction degree indicates whether the buyer is satisfied with the ordered merchandise or not.

10. The transaction system of online shopping according to claim 7, wherein when the buyer is unsatisfied with the ordered merchandise and returns it to the seller before an expiration of cooling-off period, the third party financial host returns the transaction amount to the buyer.
